(19) United States
(12) Patent Application Publication
(10) Pub. No.: US 2012/0242849 A1
(43) Pub. Date: Sep. 27, 2012

(54) Assisted Image Capture

(75) Inventor: Scott M. Herz, San Jose, CA (US)

(73) Assignee: Apple Inc., Cupertino, CA (US)

(21) Appl. No.: 13/052,781

(22) Filed: Mar. 21, 2011

(51) Int. Cl. H04N 5/228; H04N 5/225

(52) U.S. Cl. 348/208.99; 348/207.99; 348/E05.031; 348/E05.024

(57) ABSTRACT

Techniques for assisting the user of a digital image capture device take a well composed image are described. In general, a first image may be displayed and then stabilized (or frozen) on the display if it is determined to be well composed. A subsequent image may replace the stabilized image on the display if it is not substantially the same as the stabilized image. A stabilized image may also be tagged with one or more visual cues so as to notify the user the image is well composed.

### BACKGROUND

This disclosure relates generally to the field of digital image capture and processing. More particularly, but not by way of limitation, this disclosure relates to systems, methods, and computer readable medium for assisting the user of a digital image capture device take a well composed image.

As the cost of manufacturing Charged Coupled Devices (CCDs) and Complementary Metal Oxide Semiconductor (CMOS) image sensors has come down, the number of devices incorporating them has increased. In turn, as the number of devices incorporating digital imaging capability has increased, so too has the number of people making use of them. It is now common to find digital camera functionality (still and video) incorporated into many commercial devices such as notebook computers, tablet computers, desktop computers, portable music devices and mobile telephones.

While knowledgeable photographers may know various techniques to determine when a picture is well composed, the majority of individuals making use of digital image capture devices do not. Thus, it would be beneficial to provide a mechanism by which a user could know when an image is well composed.

### SUMMARY

In one embodiment the invention provides a method to capture and display an image generated by a digital image capture device. If the image is determined to be well composed, it may be stabilized on the display. (That is to say, a point in the displayed scene remains in a fixed location relative to the display.) Once stabilized, the image's selected point (e.g., the center point of the image as displayed) will not appear to move on the display even when the digital image capture device is moved small amounts. A subsequent image will replace a stabilized image if the two are not substantially the same. In another embodiment, a stabilized image may also be badged to provide an additional visual cue to the user that the displayed image is well composed. In general, any desired composition rule may be applied to captured images. Illustrative composition rules include, but are not limited to, the rule of thirds, golden section rule, lines rule, diagonal rule, geometric shapes rule, framing rule, balance rule, no middle rule, and the empty space rule. Each of these rules can identify conditions that, if satisfied, suggest an image is well composed. In accordance with some embodiments, one or more composition rules may be applied at a time.

Methods in accordance with various embodiments may be implemented in software (as one or more program modules), hardware or a combination of software and hardware. Illustrative hardware platforms that may benefit from the disclosed methods include notebook computers, tablet computers, desktop computers, portable music devices and mobile telephones. In addition, methods embodied in software may be tangibly retained on substantially any long-term recording medium.

### BRIEF DESCRIPTION OF THE DRAWINGS

FIGS. 1A and 1B show illustrative digital image capture devices.

FIG. 2 shows, in flowchart form, image capture and display operation in accordance with one embodiment.

FIG. 3 illustrates the difference in the amount of a scene captured by a device and the amount presented to a user.

FIG. 4 shows, in flowchart form, a detailed view of certain operation in accordance with FIG. 2.

FIG. 5 shows, in flowchart form, an image capture and display operation in accordance with another embodiment.

FIGS. 6A and 6B show two illustrative badging approaches.

FIG. 7 shows, in block diagram form, an image capture device in accordance with one embodiment.

FIG. 8 shows, in block diagram form, an image capture device in accordance with another embodiment.

### DETAILED DESCRIPTION

This disclosure pertains to systems, methods, and computer readable medium for assisting the user of a digital image capture device take a well composed image. In general, techniques are disclosed herein for stabilizing an image in the digital image capture device's (e.g., preview) display so as to indicate to the user that the image is well composed—thereby assisting the user in capturing quality images. Once stabilized, a selected point or location in the image does not appear to move in the display for small motions of the device itself. If the image capture device is moved more than a small amount, the display is unfrozen whereafter the display tracks the view of the image capture device in a normal manner. In addition to stabilizing the displayed image, additional visual cues may be presented in the device's display.

In the following description, for purposes of explanation, numerous specific details are set forth in order to provide a thorough understanding of the inventive concept. As part of the this description, some structures and devices may be shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the digital image processing field having the benefit of this disclosure.

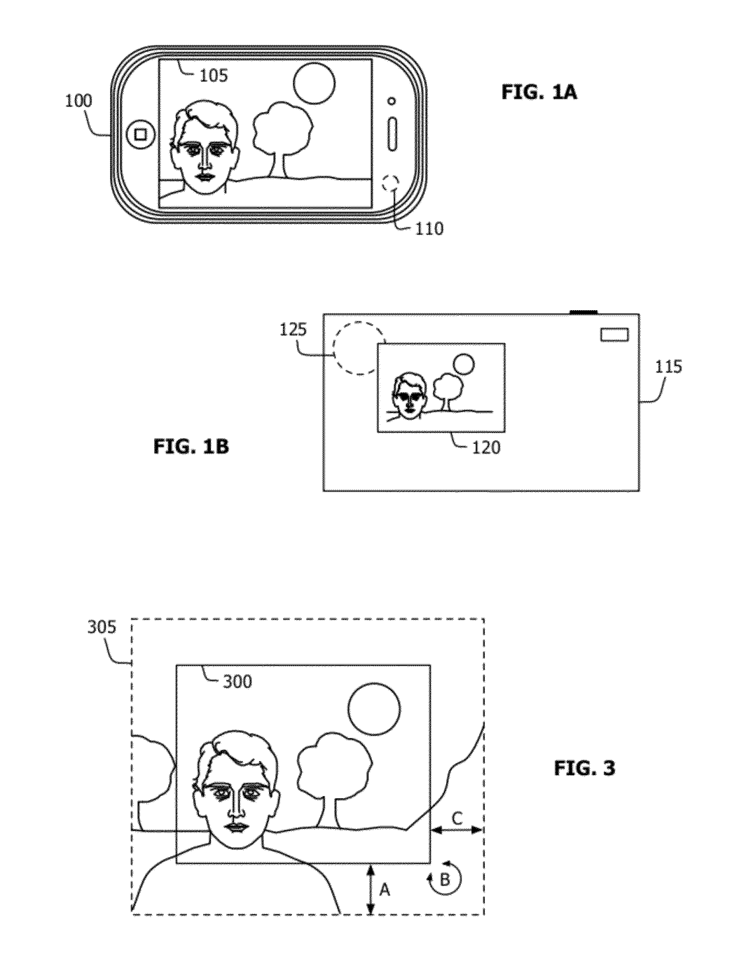

As used herein the terms “digital image capture device,” “image capture device” or, more simply, “camera” are meant to mean any instrument capable of capturing digital images (including still and video sequences). FIG. 1 illustrates two such devices: FIG. 1A shows mobile phone 100 with display/preview screen 105 (and lens 110); FIG. 1B shows digital camera 115 with display screen 120 (and lens 125). Either mobile phone 100 or camera 115 may capture video as well as still images.

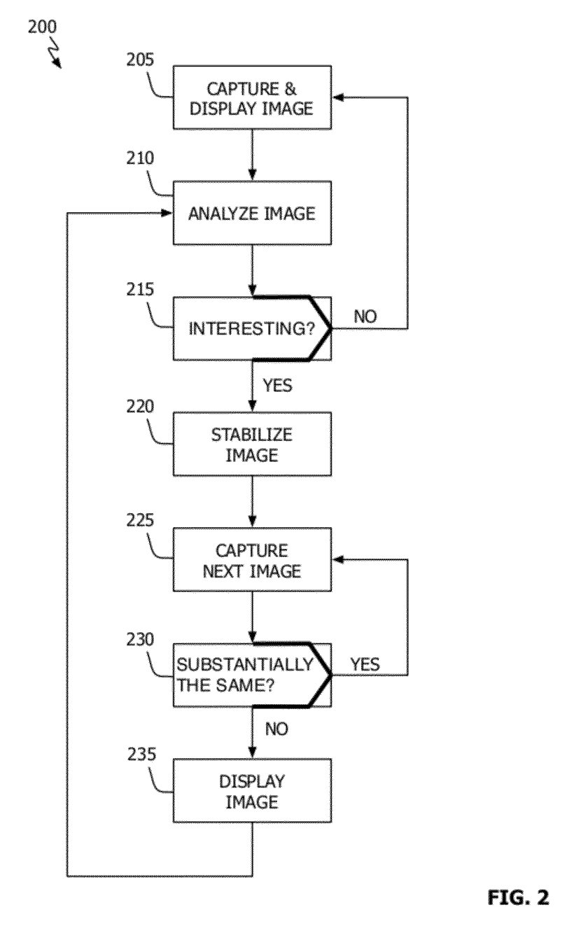

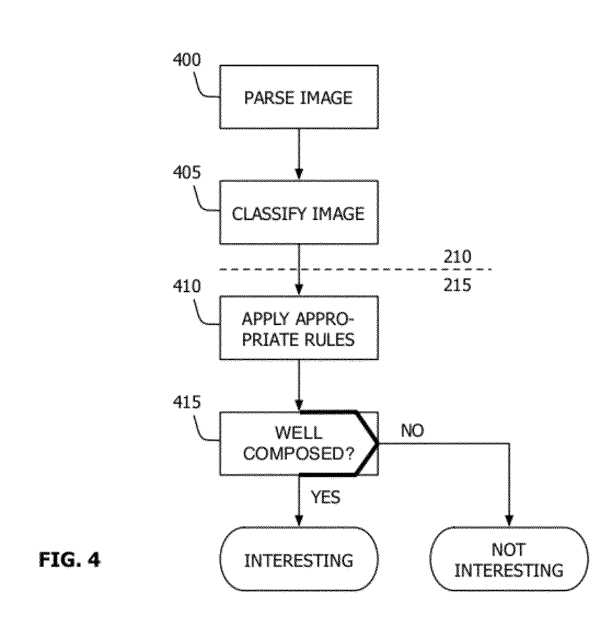

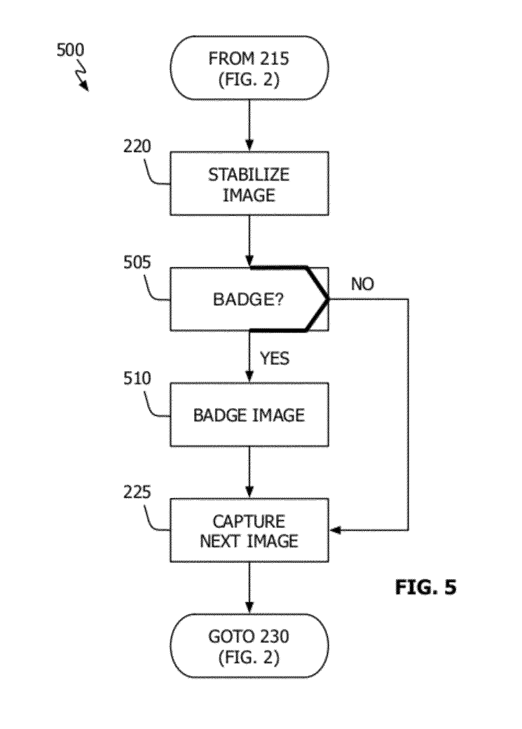

Referring to FIG. 2, image capture and display operation 200 in accordance with one embodiment begins when an initial image is captured and displayed on, for example, preview display 105 or 120 (block 105). The image may then be analyzed (block 210). Any image analysis technique now know or later developed may be used as long as the resulting “detected objects” may be evaluated in accordance with block 215 (discussed below). For example, image analysis 210 may utilize object detection (e.g., face recognition and/or line and object detection) or histogram analysis. Once the image has been analyzed, the result(s) of that analysis may be evaluated to determine if the image is interesting (block 215). As used herein, the term “interesting” means that the image includes one or more objects that satisfy certain conditions. In one embodiment, “interesting” means the image meets one or more established criteria for being well composed (discussed more fully below).

If the image is determined not to be interesting (the “NO” prong of block 215), operation 200 returns to block 205. If the displayed image is determined to be interesting (the “YES” prong of block 215), the displayed image may be stabilized (block 220). As used herein, the term “stabilized” means that a location in the image presented to the user via, for example, preview displays 105 or 120, is fixed or frozen with respect to the display such that small motions of the device are not reflected in the display. For example, if a scene includes a person's head and that person is talking, when stabilized, perhaps the center point of the displayed image remains fixed or frozen with respect to the display but other movement within the displayed image (such as the person's lips) would continue to be displayed as normal. Once the current image is stabilized, the next image may be captured (block 225) and checked to determine if the two images are substantially the same (block 230). As used herein, a second image is substantially the same as a first image if the second image is merely a translated version of the first image. A further requirement is that the amount of translation be less than a specified amount.

Referring to FIG. 3, image stabilization techniques in accordance with block 220 generally rely on presenting an image to the user 300 that is smaller than the image actually captured by the device's sensor element 305. Operations in accordance with various embodiments make use of this feature to permit small motions of the device while maintaining the location of a selected point of the displayed image in the display. It will be recognized that the amount of translation allowed in any given direction (e.g., A and/or B and/or C) without failing the check of block 230 may be dependent upon the difference in what is actually captured by the device (i.e., 305) and what is displayed to the user (i.e., 300).

Returning to FIG. 2, if the most recently captured image (in accordance with block 225) is substantially the same as the currently displayed image (the “YES” prong of block 230), operations return to block 225. If, on the other hand, the most recently captured image is not substantially the same as the currently displayed image (the “NO” prong of block 230), the most recently captured image is displayed (block 235), whereafter operation 200 resumes at block 210. It will be noted that acts in accordance with block 235 may replace the currently displayed image.

With reference to FIG. 3 and block 230 of FIG. 2, in one embodiment a first image may be considered substantially the same if translation about all measured directions (e.g., A and/or B and/or C) are less than a specified threshold. In another embodiment, a first image may be considered substantially the same if translation about any one of the measured directions (e.g., A and/or B and/or C) is less than a specified threshold. As noted above, the specified threshold will, in general, be based on the amount of an image presented to the user (e.g., region 300) and the area actually captured by the device's sensor element (e.g., region 305).

Referring now to FIG. 4, the interplay between the acts of blocks 210 and 215 is illustrated. To begin, the image may be parsed (block 400) whereafter it may be classified (bock 405). As used here, the term “parse” means to analyze the image in a manner and to the extent needed to classify the image (block 405) and then to apply the appropriate rules (block 410). In one embodiment, acts in accordance with block 400 may perform object detection such that the image may be classified in accordance with block 405 as comprising a landscape or people. In another embodiment, the number of possible classifications may be greater such as when imaging a number of types of scenes having known characteristics. In still another embodiment, the number of possible classifications may be fewer such as when only a single type of object may be considered interesting (e.g., human faces).

Once the type of image has been parsed and classified, its characteristics may be applied to one or more appropriate rules (block 410). For example, one set of rules may be applicable when evaluating an image that includes a single human face, another set of rules may be applicable when evaluating an image that includes multiple human faces and yet another set of rules may be applicable when evaluating, for example, landscapes. While the following claims are not so limited, embodiments described here assume the rules evaluate whether an image is well composed (block 415). If the image is determined to be well composed (the “YES” prong of block 415), the image is interesting. If the image is determined not to be well composed (the “NO” prong of block 415), the image is not interesting.

Illustrative composition rules include, but are not limited to: rule of thirds; golden section rule, lines rule, diagonal rule, geometric shapes rule; framing rule; balance rule; no middle rule; and the empty space rule. In addition, histograms may be used as is known in the art. It will be recognized, each of these techniques identify conditions that if met (in accordance with criteria set by the developer) may identify an image as well composed. In one embodiment, a single rule may be used (block 410) when evaluating whether an image is interesting (block 415). For example, if a single person is detected, the rule of thirds may be applied. In another embodiment, multiple rules may be employed. For example, if a single person is detected, the rule of thirds and the no middle rule may be applied. Alternatively, if multiple people are detected, the golden section rule and balance rule may be applied. In like manner, if a landscape scene is being captured, the diagonal rule, lines rule and framing rule may be evaluated. The term “rule,” as used here, is not meant to imply a hard-and-fast (e.g., if-then) type of operation. In practice, composition rules may be better thought of as heuristics to which the developer assigns criteria that, if met, indicates the rule has been satisfied. As such, multiple rules may be satisfied at the same time or output from different rules may be contradictory. In such a case, rule output may be weighted or prioritized.

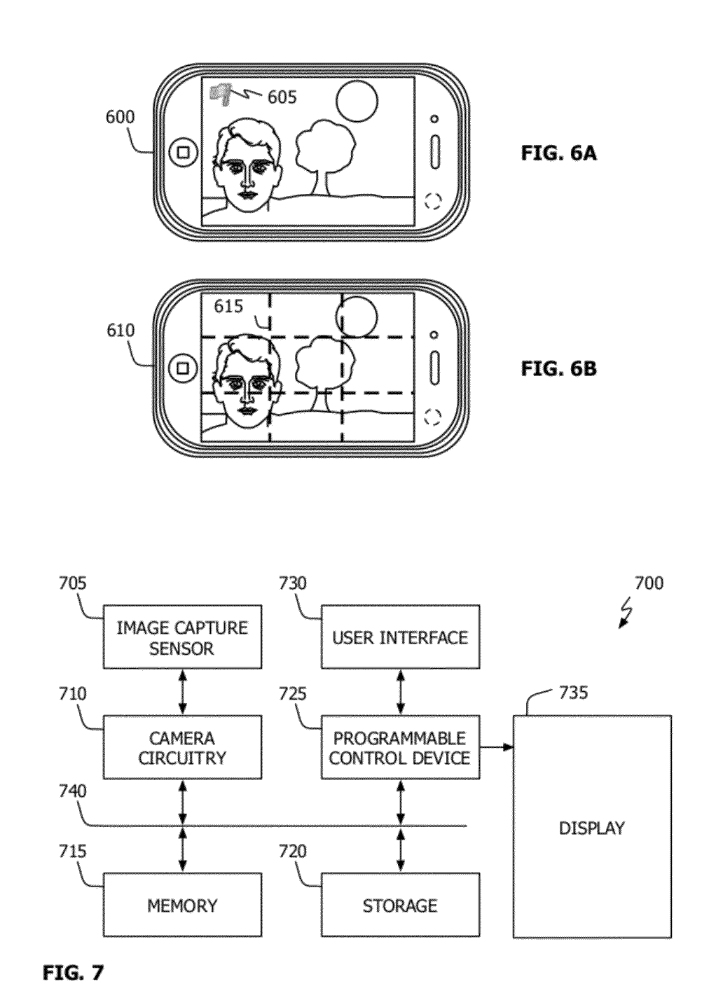

In another embodiment, in addition to stabilizing an image it may be badged to further indicate to a user the image has been judged to be well composed. As used herein, the term “badging” means to display a visual cue to the user that is not in the view itself. Referring to FIG. 5, badging assisted image capture operation 500 may be seen as modifying operation 200. Thus, once an imaged judged to be well composed has been stabilized (block 220), a check may be made to determine if a badging operation is desired (block 505). If badging is not desired (the “NO” prong of block 505), operations continue at block 225 as in operation 200. If badging is desired (the “YES” prong of block 505), the displayed stabilized imaged may be badged (block 510) whereafter operations continue at block 225. Two illustrative types of badges are shown in FIGS. 6A and 6B. In the former, image capture device 600 may display flag 605 as an indication to the user. In the latter, image capture device 610 may display a rule of thirds (or golden section rule) grid 615. In some embodiments the badge (e.g., flag 605 or grid 615) may be prominently displayed. In other embodiments, badging may be less conspicuous.

Referring now to FIG. 7, a simplified functional block diagram of image capture device 700 is shown (e.g. digital camera 115) that includes image capture sensor 705 and associated camera circuitry 710, memory 715, storage 720, processor 725, user interface 730, display 735, and communications bus 740. Camera circuitry 710 (in combination with sensor 705) may provide still or video image capture capability. Memory 715 may include one or more types of memory for performing device functions. For example, memory 715 may include cache, Read Only Memory (ROM) and/or Random Access Memory (RAM). Storage 720 may store media (e.g., image and video files), software/programs (e.g., for implementing various functions on device 700), preference information, device profile information, and any other suitable data. Storage 720 may include one more long-term/permanent (i.e., tangible) storage mediums. Processor 725 may control the overall operation of device 700 and may be any suitable programmable control device. User interface 730 may allow a user to interact with device 700 and can take a variety (or combination) of forms, such as a button, keypad, dial, click wheel, or a touch screen (e.g., through display 735). Communications bus 740 may provide a data transfer path for transferring data to, from, or between at least camera circuitry 710, memory 715, storage 720 and processor 725.

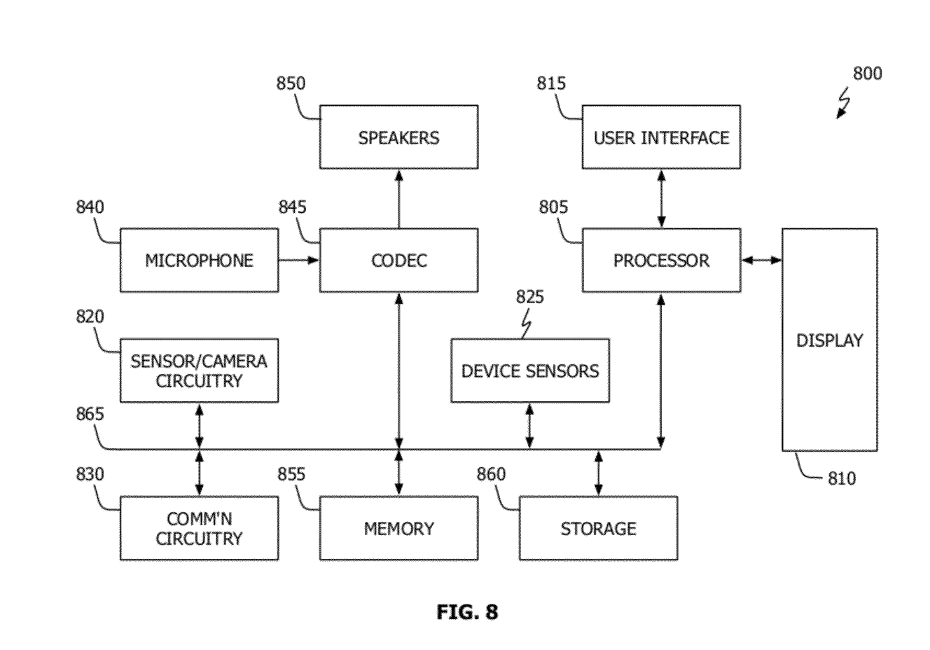

Referring to FIG. 8, a simplified functional block diagram of another image capture device 800 is shown (e.g., mobile phone 100). Device 800 may include processor 805, display 810, user interface 815, image sensor with associated camera hardware 820, device sensors 825 (e.g., ambient light, proximity and/or accelerometer sensors), communication circuitry 830 (including microphone 840, CODEC 845 and speakers 850), memory 855, storage 860, and communications bus 865. As before, processor 805 may be any suitable programmable control device that can drive display 810 and receive input from (and control) user interface 815 and device sensors 825. Communication circuitry 830, in combination with microphone 840, CODEC 845 and speakers 850 may provide mobile phone (and, perhaps, music playback and/or record) functionality. Memory 855, storage 860, and communication's bus 865 may perform similarly to that described above with respect to elements 715, 720, and 740.

Processors 725 and 805 may include any programmable controller device including, for example, one or more members of the Intel Atom®, Core®, Pentium® and Celeron® processor families from Intel Corporation and the Cortex and ARM processor families from ARM or custom designed state machines. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Custom designed state machines may be embodied in a hardware device such as application specific integrated circuits (ASICs) and field programmable gate array (FPGAs).

Storage devices suitable for tangibly embodying image data, operational data and program instructions (e.g., storage 720 and 860) include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

Various changes in the materials, components, circuit elements, as well as in the details of the illustrated operational methods are possible without departing from the scope of the following claims. For example, it will be recognized that the type of image analysis that may be needed (e.g., in accordance with block 210) may be at least partly driven by the type of methodology used to determine if an image is interesting (e.g., in accordance with block 215). For example, if only a single type of image is to be considered interesting (e.g., only those in which people are detected), then all images not having the necessary characteristics may be rapidly determined to be not interesting. On the other hand, if there are a number of different types of images that could be considered interesting (e.g., one person, multiple people, landscapes, barcodes, airplanes, . . . ), the amount of image analysis may be significant. In addition, the precise technique to stabilize an interesting image (e.g., in accordance with block 220) is up to the developer and may include any known or later developed technique. Further, the amount of device movement that may be considered insignificant (that is, to meet the “substantially same” test of block 230) may be dependent on the stabilization methodology and/or the amount of memory dedicated to the display (e.g., elements 105, 120, 300, 600, 610, 735 and 810) as compared to the memory used to capture image sensor information. In like manner, the act of displaying a new image (e.g., in accordance with block 235) may employ a simple replacement operation or a more sophisticated technique wherein the currently displayed image is animated to the replacement image.

It will also be recognized that operations in accordance with this disclosure (e.g., operations 200, 400 and 500) may be performed by a programmable control device (as described above) executing instructions organized into one or more program modules. Storage devices suitable for tangibly embodying program instructions include all types of non-transitory storage such as those described above (e.g., 720 and 860).

Finally, it is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method to assist the capture of a well composed image, comprising:
displaying a first image on a display;
receiving an indication that the first image is well composed;
freezing the first image on the display;
obtaining a second image; and
replacing the first image with the second image on the display if the second image is not substantially the same as the first image, else continuing to freeze the first image on the display.

2. The method of claim 1, wherein the act of displaying the first image on the display further comprises badging the first image.

3. The method of claim 2, wherein the act of badging the first image comprises displaying a grid on the display with the first image.

4. A method to assist image capture, comprising:
obtaining, by a digital image capture device, a first image;
displaying, by the digital image capture device, the first image on a display;
determining, by the digital image capture device, the first image is well composed;
stabilizing, by the digital image capture device, the first image on the display;
acquiring, by the digital image capture device, a second image;
determining, by the digital image capture device, if the second image is substantially the same as the first image; and
continuing to display, by the digital image capture device, the first image on the display if the second image is substantially the same as the first image otherwise displaying the second image on the display.

5. The method of claim 4, wherein the act of determining if the first image is well composed comprises applying one or more pre-specified rules.

6. The method of claim 5, wherein at least one of the one or more pre-specified rules comprises the rule-of-thirds.

7. The method of claim 4, wherein the act of displaying the first image on the display further comprises badging the first image.

8. The method of claim 7, wherein the act of badging the first image comprises displaying a grid on the display with the first image.

9. The method of claim 4, wherein the act of determining if the second image is substantially the same as the first image comprises determining if the first and second images are translated versions of the same scene, wherein the amount of translation is less than a specified amount.

10. The method of claim 4, wherein the act of displaying the second image on the display comprises replacing the first image with the second image.

11. A digital image capture device comprising:
an image sensor;
digital image capture circuitry communicatively coupled to the image sensor;
a display; and
one or more control devices, at least one of which is communicatively coupled to the digital image capture circuitry and the display, the one or more control devices adapted to perform the method of claim 1.

12. The digital image capture device of claim 11, wherein at least one of the one or more control devices is further adapted to badge the stabilized image.

13. A digital image capture device comprising:
an image sensor;
digital image capture circuitry communicatively coupled to the image sensor;
a display; and
one or more control devices, at least one of which is communicatively coupled to the digital image capture circuitry and the display, the one or more control devices adapted to perform the method of claim 4.

14. The digital image capture device of claim 13, wherein at least one of the one or more control devices is further adapted to badge the stabilized image.

15. A program storage device, readable by a programmable control device, comprising instructions stored thereon for causing the programmable control device to perform the method of claim 1.

16. A program storage device, readable by a programmable control device, comprising instructions stored thereon for causing the programmable control device to perform the method of claim 4.

17. A method to assist image capture, comprising:
obtaining a first image of a scene;
displaying the first image on a display;
determining one or more characteristics of the first image satisfy one or more composition rules;
stabilizing the first image on the display to produce a stabilized image;
obtaining a second image of the scene;
determining an amount of translation between the first and second images;
continuing to display the stabilized image on the display if the amount of translation is less than or equal to a threshold; and
replacing the stabilized image on the display with the second image if the amount of translation is greater than the threshold.

18. The method of claim 17, wherein the act of determining one or more characteristics of the first image satisfy one or more composition rules, comprises determining object placements in the first image satisfy a rule-of-thirds composition rule.

19. The method of claim 17, wherein the act of determining an amount of translation between the first and second images comprises:
determining a first amount of translation in a first direction; and
determining a second amount of translation in a second direction.

20. The method of claim 19, wherein the act of continuing to display the stabilized image on the display if the amount of translation is less than a threshold, comprises:
determining that the first amount of translation is less that a first specified amount; and
determining the second amount of translation is less than a second specified amount.

21. A program storage device, readable by a programmable control device, comprising instructions stored thereon for causing the programmable control device to perform the method of claim 17.

22. A digital image capture device, comprising:
an image sensor unit;
a memory operatively coupled to the image sensor unit;
a display operatively coupled to the memory;
a processor operatively coupled to the memory and display, the processor adapted to execute instructions stored in the memory to—
access a first image in the memory, the first image having been captured by the image sensor unit;
display the first image on the display;
determine one or more characteristics of the first image satisfy one or more composition rules;
stabilize the first image on the display to produced a stabilized image;
access a second image in the memory, the second image having been captured by the image sensor unit;
determine an amount of motion between the first and second images;
continue displaying the stabilized image on the display if the amount of motion is less than a threshold value; and
replace the stabilized image on the display with the second image if the amount of motion is greater than the threshold value.
